(19) United States
(12) Patent Application Publication
(10) Pub. No.: US 2018/0039895 A1
(43) Pub. Date: Feb. 8, 2018

(54) DATA PREDICTING METHOD AND APPARATUS

(71) Applicant: BEIJING BAIDU NETCOM SCIENCE AND TECHNOLOGY CO., LTD., Beijing (CN)

(72) Inventors: Bo WANG, Beijing (CN); Beibei MIAO, Beijing (CN); Dong WANG, Beijing (CN); Yun CHEN, Beijing (CN); Xuanyou GUO, Beijing (CN); Xianping QU, Beijing (CN)

(73) Assignee: BEIJING BAIDU NETCOM SCIENCE AND TECHNOLOGY CO., LTD., Beijing (CN)

(21) Appl. No.: 15/495,442

(22) Filed: Apr. 24, 2017

(30) Foreign Application Priority Data
Aug. 2, 2016 (CN) 201610624838.7

(51) Int. Cl. G06N 5/04; G06F 17/30

(52) U.S. Cl. CPC G06N 5/04; G06F 17/30294

(57) ABSTRACT

The present disclosure provides a data predicting method and apparatus. The method comprises: acquiring at least one time factor of a prediction moment; predicting a desired value of data of the prediction moment according to a preset data model and said at least one time factor of the prediction moment. As compared with a method of predicting the desired value on a year-on-year basis or a month-on-month basis in the prior art, the above technical solution of the present disclosure may effectively improve the prediction accuracy of the desired value of the data of the prediction moment and thereby improve a monitoring effect of monitoring abnormality according to the desired value of the predicted data.

The present application claims the priority of Chinese Patent Application No. 2016106248387, filed on Aug. 2, 2016, with the title of “Data predicting method and apparatus”.

### FIELD OF THE DISCLOSURE

The present disclosure relates to the technical field of data processing, and particularly to a data predicting method and apparatus.

### BACKGROUND OF THE DISCLOSURE

Along with the development of science and technology, various Internet-dependent data increases abruptly, and service data is very important and directly affects normal operation of relevant services on the Internet.

For example, the Internet companies generate a lot of operation and maintenance data and relevant service data themselves every day, for example, service line turnover, Queries Per Second (QPS) of a module, machine memory, and utilization rate of a Central Processing Unit (CPU). In use, these data need to be monitored uninterruptedly. When data indices get abnormal, an alarm will be sent to an operation and maintenance engineer in time to remind the operation and maintenance engineer to concern service operation states and avoid long-term loss of services. Furthermore, these data are in diverse types and in huge amount and fluctuate differently. During operation and maintenance, to effectively monitor these data, it is usual to judge whether the current data are abnormal by a method of judging whether a difference between a current actual value and a desired value exceeds a preset threshold, so that accuracy prediction of the desired value becomes a key point of abnormality monitoring. In the prior art, many data are positively correlated to the user's access amount so that these data have a very obvious periodicity property. Hence, a method of comparison on a year-on-year basis or a month-on-month basis is usually employed to predict a desired value, for example, predicting a flow value at a certain moment usually employs a value at the same moment of last cycle (e.g., yesterday, last week, last month or last year) as a desired value.

However, many periodic data in operation and maintenance services are also affected by factors such as holidays, festivals, weekdays and weekends. A current desired value predicting method only simply uses the data of last cycle as the desired value, causes poor accuracy of the predicted desired value and thereby causes a very undesirable abnormality monitoring effect.

### SUMMARY OF THE DISCLOSURE

The present disclosure provides a data predicting method and apparatus to improve accuracy of a predicted desired value and thereby improve an abnormality controlling effect.

The present disclosure provides a data predicting method, the method comprising:

acquiring at least one time factor of a prediction moment;

predicting a desired value of data of the prediction moment according to a preset data model and said at least one time factor of the prediction moment.

Further optionally, in the aforesaid method, before predicting a desired value of data of the prediction moment according to a preset data model and said at least one time factor of the prediction moment, the method further comprises:

acquiring historical valid data;

acquiring at least one time factor of each data point of the historical valid data;

determining the preset data model according to the historical valid data and the at least one time factor of corresponding each data point.

Further optionally, in the aforesaid method, acquiring at least one time factor of each data point of the historical valid data specifically comprises:

acquiring a timestamp of each data point of the historical valid data;

extracting at least one time factor of the corresponding data point from the timestamp of each data point of the historical valid data.

Further optionally, in the aforesaid method, the at least one time factor comprises: which second of the current day the moment corresponding to the data point is, whether a date including the moment corresponding to the data point is a weekday, which day of a current week the date including the moment corresponding to the data point is, which day of a current month the date including the moment corresponding to the data point is, whether the date including the moment corresponding to the data point is a holiday or festival, and if the date including the moment corresponding to the data point is a holiday or festival, at least one of which holiday or festival.

Further optionally, in the aforesaid method, determining the preset data model according to the historical valid data and the at least one time factor of corresponding each data point specifically comprises:

enabling said at least one time factor of each said data point in the historical valid data to form a preset time vector;

considering the preset time vector as an input value of the preset data model, considering the data of a corresponding said data point as an output value of the preset data model, training the preset data model, and determining the preset data model.

Further optionally, in the aforesaid method, predicting a desired value of data of the prediction moment according to a preset data model and said at least one time factor of the prediction moment specifically comprises:

enabling at least one time factor of the prediction moment to form a time vector;

considering the time vector as an input of the preset data model, and obtaining an output value of the preset data model;

considering the output value of the preset data model as a desired value of the data of the prediction moment.

The present disclosure further provides a data predicting apparatus, comprising:

an acquiring module configured to acquire at least one time factor of a prediction moment;

a predicting module configured to predict a desired value of data of the prediction moment according to a preset data model and said at least one time factor of the prediction moment.

Further optionally, the aforesaid apparatus further comprises a determining module;

the acquiring module is further configured to acquire historical valid data;

the acquiring module is further configured to acquire at least one time factor of each data point of the historical valid data;

the determining module is configured to determine the preset data model according to the historical valid data and the at least one time factor of corresponding each data point.

Further optionally, in the aforesaid apparatus, the acquiring module is specifically configured to acquire a timestamp of each data point of the historical valid data;

extract at least one time factor of the corresponding data point from the timestamp of each data point of the historical valid data.

Further optionally, in the aforesaid apparatus, the at least one time factor comprises: which second of the current day the moment corresponding to the data point is, whether a date including the moment corresponding to the data point is a weekday, which day of a current week the date including the moment corresponding to the data point is, which day of a current month the date including the moment corresponding to the data point is, whether the date including the moment corresponding to the data point is a holiday or festival, and if the date including the moment corresponding to the data point is a holiday or festival, at least one of which holiday or festival.

Further optionally, in the aforesaid apparatus, the determining module is specifically configured to:

enable said at least one time factor of each said data point in the historical valid data to form a preset time vector;

consider the preset time vector as an input value of the preset data model, consider the data of a corresponding data point as an output value of the preset data model, train the preset data model, and determine the preset data model.

Further optionally, in the aforesaid apparatus, the predicting module is specifically configured to:

enable at least one time factor of the prediction moment to form a time vector;

consider the time vector as an input of the preset data model, and obtain an output value of the preset data model;

consider the output value of the preset data model as a desired value of the data of the prediction moment.

According to the data predicting method and apparatus of the present disclosure, at least one time factor of the prediction moment is acquired, and a desired value of data of the prediction moment is predicted according to the preset data model and said at least one time factor of the prediction moment. As compared with a method of predicting the desired value on a year-on-year basis or a month-on-month basis in the prior art, the present disclosure may effectively improve the prediction accuracy of the desired value of the data of the prediction moment and thereby improve a monitoring effect of monitoring abnormality according to the desired value of the predicted data.

### BRIEF DESCRIPTION OF DRAWINGS

FIG. 1 is a flow curve diagram of a certain company within one week in the prior art.

FIG. 2 is a flow chart of an embodiment of a data predicting method according to the present disclosure.

FIG. 3 is a block diagram of Embodiment 1 of a data predicting apparatus according to the present disclosure.

FIG. 4 is a block diagram of Embodiment 2 of a data predicting apparatus according to the present disclosure.

### DETAILED DESCRIPTION OF PREFERRED EMBODIMENTS

To make objectives, technical solutions and advantages of the present disclosure more apparent, the present disclosure will be described in detail with reference to figures and specific embodiments.

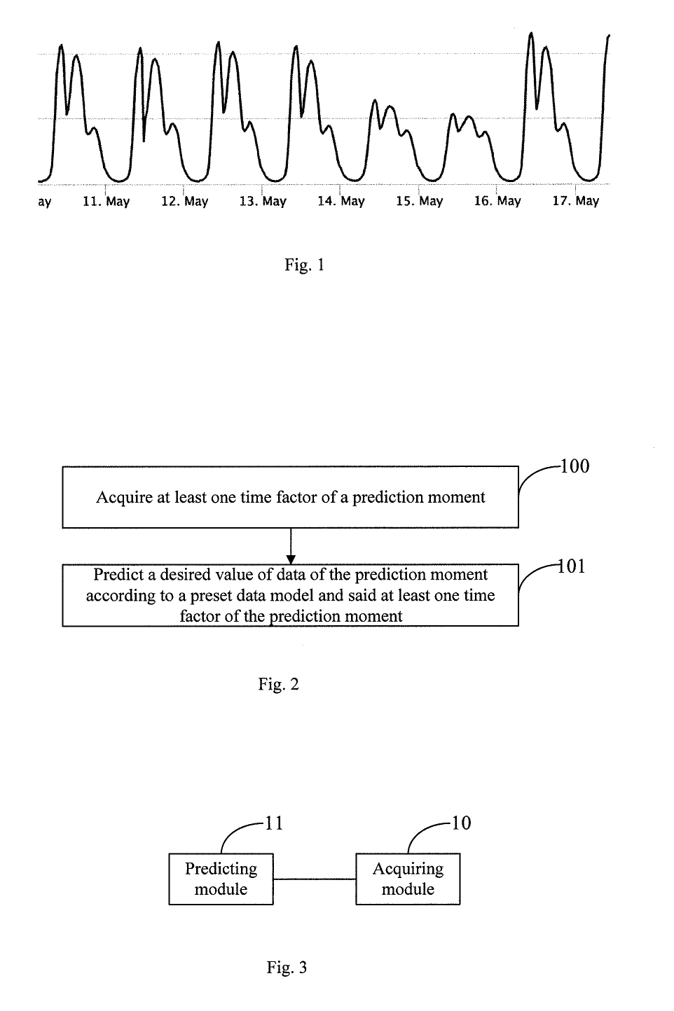

In the prior art, the flow of many Internet companies exhibits distinct waveforms on weekdays and weekends. For example, FIG. 1 is a flow curve diagram of a certain company within one week in the prior art. As shown in FIG. 1, May 11 through May 14 are Tuesday through Friday, May 15 through May 16 are Saturday through Sunday, and May 17 is Monday. As can be seen from FIG. 1, the flow curve of the company varies within one week. If day is taken as a cycle, when an desired value at a certain moment is predicted in a year-on-year method or a month-on-month method, it is relatively desirable to employ a method of predicting an desired value by using a flow value at the same moment of a weekday to predict a flow value at the same moment next weekday, for example, using the flow value at the same moment of for example Monday of last cycle to predict an desired value at the same moment of Tuesday, or using the flow value at the same moment of for example Tuesday of last cycle to predict an desired value at the same moment of Wednesday.

Since many service data are positively correlated to the user's access amount so that these data have a very obvious periodicity property. However, the user's access is also affected by factors such as weekdays, weekends, irregular holidays and festivals and special events. For example, as for the flow curve in FIG. 1, if the flow value at the same moment of Sunday is employed to predict an desired value at the same moment of Monday, a desired value with a larger error will be obtained; if the desired value with a larger error is employed for data monitoring, this causes normal flow to be considered as abnormal flow so that an alarm will be sent and a very undesirable monitoring effect is caused.

Based on the above technical problems, the concept of time factor is introduced in the present disclosure for periodic data; model parameters of a preset data model are obtained through training based on historical valid data, to achieve more accurate prediction of a desired value at a prediction moment and thereby implement more effective system monitoring and alarming. The technical solutions of the present disclosure will be described in detail with reference to the following embodiments. FIG. 2 is a flow chart of an embodiment of a data predicting method according to the present disclosure. As shown in FIG. 2, the data predicting method according to the present embodiment may specifically comprise the following steps:
100: acquiring at least one time factor of a prediction moment;
101: predicting a desired value of data of the prediction moment according to a preset data model and said at least one time factor of the prediction moment.

A subject for executing the data predicting method according to the present embodiment is a data predicting apparatus. The data predicting apparatus has a monitoring center that may be arranged in a system to predict the desired value of the data at the prediction moment, and according to the desired value of the data at the prediction moment and a current value when the prediction moment comes, judge whether data of the current value is abnormal so that the monitoring center of the system sends an alarm when the data gets abnormal to advisor a staff member of occurrence of abnormality such that the staff member repairs the abnormality as quick as possible.

The prediction moment of the present embodiment may comprise at least one time factor, and each time factor is used to identify a parameter of time of the current moment. For example, said at least one time factor may specifically comprise: which second of the current day the prediction moment is, whether a date including the prediction moment is a weekday, which day of a current week the date including the prediction moment is, which day of a current month the date including the prediction moment is, whether the date including the prediction moment is a holiday or festival, and if the date including the prediction moment is a holiday or festival, at least one day of which holiday or festival. In practical operation, if the content included by the time factor of the prediction moment is richer, the desired value of the data prediction is more accurate. The data in the present embodiment may be flow data, or may also be other service data, and is not limited herein.

Then, it is feasible to predict the desired value of the data of the prediction moment according to the preset data model and said at least one time factor of the prediction moment. The preset data model in the present embodiment is a model about the time factor. In the preset data model, the model parameter is already known. When said at least one time factor of the preset moment is acquired, it is feasible to predict the desired value of the data of the prediction moment according to said at least one time factor of the prediction moment and the preset data model.

The preset data model of the present embodiment may be a Back Propagation (BP) data model which is duly trained and whose model parameters have already been determined, and the BP data model is specifically one BP neural network model.

According to the data predicting method of the present embodiment, at least one time factor of the prediction moment is acquired, and a desired value of data of the prediction moment is predicted according to the preset data model and said at least one time factor of the prediction moment. As compared with a method of predicting the desired value on a year-on-year basis or a month-on-month basis in the prior art, the present disclosure may effectively improve the prediction accuracy of the desired value of the data of the prediction moment and thereby improve a monitoring effect of monitoring abnormality according to the desired value of the predicted data. Further optionally, on the basis of the technical solution of the embodiment as shown in the above figure, before the step 101 “predicting a desired value of data of the prediction moment according to a preset data model and said at least one time factor of the prediction moment”, the method may further comprise the following steps:

(a1) acquiring historical valid data;

For example, in the present embodiment, the historical valid data may be specifically acquired from the monitoring center of the system. specifically, a lot of historical monitoring source data may be collected and read from the monitoring center of the system. Specifically, it is feasible to acquire historical monitoring source data in last month, or acquire historical monitoring source data in one year, or acquire historical monitoring source data in one week. Upon specifically acquiring, it is feasible to, according to service periodicity corresponding to the data, personally analyze what historical monitoring source data are used to predict a more accurate desired value of the data of the prediction moment, and then acquire historical monitoring source data in a corresponding historical time period, and then perform data cleaning for the acquired historical monitoring source data. For example, the data cleaning procedure may specifically comprise performing simple denoising for the historical monitoring source data. Specifically, it is feasible to clean the historical monitoring source data by using a data smoothing method, including but not limited to Kalman filtering, moving average and median filtering, to obtain the historical valid data.

(a2) acquiring at least one time factor of each data point of the historical valid data;

The historical valid data includes numberless data points in a time sequence relationship. As for each data point, a time feature of a position where the moment of the data point lies may be taken as a time factor corresponding to the data point. For example, the time factor of each time point may include which second of the current day the moment corresponding to the data point is, whether a date including the moment corresponding to the data point is a weekday, which day of a current week the date including the moment corresponding to the data point is, which day of a current month the date including the moment corresponding to the data point is, whether the date including the moment corresponding to the data point is a holiday or festival, and if the date including the moment corresponding to the data point is a holiday or festival, at least one day of which holiday or festival.

Further optionally, the step (a2) may specifically comprise the following steps:

(b1) acquiring a timestamp of each data point of the historical valid data;

(b2) extracting at least one time factor of the corresponding data point from the timestamp of each data point of the historical valid data.

Specifically, the timestamp may be a time feature of a position where the moment of each data point in the historical valid data lies. Each time feature is a parameter identifying time and serves as a time factor. For example, the time factor may specifically comprise which second of the current day the moment corresponding to the data point is, whether a date including the moment corresponding to the data point is a weekday, which day of a current week the date including the moment corresponding to the data point is, which day of a current month the date including the moment corresponding to the data point is, whether the date including the moment corresponding to the data point is a holiday or festival, and if the date including the moment corresponding to the data point is a holiday or festival, which holiday or festival. The at least one parameter of each data point identifying time comprises at least one of the above parameters.

(a3) determining a preset data model according to the historical valid data and the at least one time factor of the corresponding each data point.

Further optionally, step (a3) may specifically comprise the following steps:

(d1) enabling at least one time factor of each data point in historical valid data to form a preset time vector;

(d2) considering the preset time vector as an input value of the preset data model, considering the data of the corresponding data point as an output value of the preset data model, training the preset data model, and determining parameters of the data model so that the preset data model is achieved;

For example, an example is presented in which the data point of the i^{th} moment comprises k time factors, and the preset time vector formed by k time factors of the data point of the i^{th} moment may be represented as.

Then, the preset time vector is regarded as the input value of the preset data model y=bp(, and the data y of the corresponding data point is regarded as the output value of the preset data model, and the preset data model y=bp(is trained to obtain a value of the parameter bp of the preset data model.

Then, it is feasible to take k time factors of the i+1^{th} moment to obtain a preset time vector of the i+1^{th} moment. According to the formula y=bp(, the preset time vector of the i+1^{th} moment is regarded as the input value of the preset data model, and the data y of the corresponding data point is regarded as the output value of the preset data model, and the preset data model is trained to update and adjust a value of the parameter bp of the preset data model. Similarly, after the preset data model is trained respectively by using the preset time vector formed by at least one time factor of all data points in the historical valid data, it is feasible to finally determine parameters of the preset data model and thereby determine the preset data model.

Furthermore optionally, since input of the preset data model such as BP data model is in a vector form, the step 101 in the above embodiment may specifically comprise the following steps:

(e1) enabling at least one time factor of the prediction moment to form a time vector;

(e2) considering the preset time vector as an input value of the preset data model, and obtaining an output value of the preset data model;

(e3) considering the output value of the preset data model as a desired value of the data of the prediction moment.

For example, in the present embodiment, with the preset data model bp in the above steps (d1)-(d3) having been determined, the time vector formed by at least one time factor of the prediction moment may be represented as; according to the formula y=bp(, the time vector is regarded as the input of the preset data model, and the output value of the preset data model may be acquired; the output value of the preset data model is regarded as the desired value of the data of the prediction moment, thereby implementing prediction of the desired value of the data of the prediction moment.

According to the data predicting method of the above embodiment, with the above technical solutions being employed, the preset data model is determined, and a desired value of data of the prediction moment is predicted according to the preset data model and said at least one time factor of the prediction moment. As compared with a method of predicting the desired value on a year-on-year basis or a month-on-month basis in the prior art, the present disclosure may effectively improve the prediction accuracy of the desired value of the data of the prediction moment and thereby improve a monitoring effect of monitoring abnormality according to the desired value of the predicted data.

FIG. 3 is a block diagram of Embodiment 1 of a data predicting apparatus according to the present disclosure. As shown in FIG. 3, the data predicting apparatus in the present embodiment may specifically comprise an acquiring module 10 and a predicting module 11.

The acquiring module 10 is configured to acquire at least one time factor of a prediction moment; the predicting module 11 is configured to predict a desired value of data of the prediction moment according to a preset data model and said at least one time factor of the prediction moment acquired by the acquiring module 10.

The data predicting apparatus of the present embodiment uses the above modules to implement the implementation mechanism of data prediction and technical effects in the same way as the above relevant method embodiments. Reference may be made to the depictions of the relevant method embodiments, which will not be detailed any more.

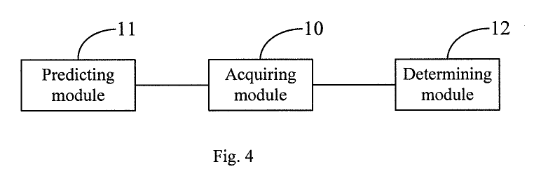

FIG. 4 is a block diagram of Embodiment 2 of a data predicting apparatus according to the present disclosure. As shown in FIG. 4, the data predicting apparatus in the present embodiment may further comprise the following technical solution on the basis of the technical solution of the embodiment shown in FIG. 3.

As shown in FIG. 4, the data predicting apparatus in the present embodiment further comprises a determining module 12.

The acquiring module 10 is further configured to acquire historical valid data; the acquiring module 10 is further configured to acquire at least one time factor of each data point of the historical valid data; the determining module 11 is configured to determine a preset data model according to the historical valid data and the at least one time factor of corresponding each data point acquired by the acquiring module 10.

Further optionally, the acquiring module 10 is specifically configured to acquire a timestamp of each data point of the historical valid data; extract at least one time factor of the corresponding data point from the timestamp of each data point of the historical valid data.

Further optionally, the at least one time factor comprises: which second of the current day the moment corresponding to the data point is, whether a date including the moment corresponding to the data point is a weekday, which day of a current week the date including the moment corresponding to the data point is, which day of a current month the date including the moment corresponding to the data point is, whether the date including the moment corresponding to the data point is a holiday or festival, and if the date including the moment corresponding to the data point is a holiday or festival, at least one of which holiday or festival.

Further optionally, in the data predicting apparatus of the present embodiment, the determining module 12 is specifically configured to:

enable at least one time factor of each data point in historical valid data to form a preset time vector;

consider the preset time vector as an input value of the preset data model, consider the data of a corresponding data point as an output value of the preset data model, train the preset data model, and determine the preset data model.

Further optionally, in the data predicting apparatus of the present embodiment, the predicting module 11 is specifically configured to:

enable at least one time factor of the prediction moment to form a time vector;

consider the time vector as an input of the preset data model, and obtain an output value of the preset data model;

consider the output value of the preset data model as a desired value of the data of the prediction moment.

The data predicting apparatus of the present embodiment uses the above modules to implement the implementation mechanism of data prediction and technical effects in the same way as the above relevant method embodiments. Reference may be made to the depictions of the relevant method embodiments, which will not be detailed any more.

In the embodiments provided by the present disclosure, it should be understood that the revealed system, apparatus and method can be implemented in other ways. For example, the above-described embodiments for the apparatus are only exemplary, e.g., the division of the units is merely logical one, and, in reality, they can be divided in other ways upon implementation.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, read-only memory (ROM), a random access memory (RAM), magnetic disk, or an optical disk.

The foregoing is only preferred embodiments of the present disclosure, not intended to limit the disclosure. Any modifications, equivalent replacements, improvements and the like made within the spirit and principles of the present disclosure, should all be included in the present disclosure within the scope of protection.

What is claimed is:

1. A data predicting method, wherein the method comprises:
acquiring at least one time factor of a prediction moment;
predicting a desired value of data of the prediction moment according to a preset data model and said at least one time factor of the prediction moment.

2. The method according to claim 1, wherein before predicting a desired value of data of the prediction moment according to a preset data model and said at least one time factor of the prediction moment, the method further comprises:
acquiring historical valid data;
acquiring at least one time factor of each data point of the historical valid data;
determining the preset data model according to the historical valid data and the at least one time factor of corresponding each data point.

3. The method according to claim 2, wherein acquiring at least one time factor of each data point of the historical valid data specifically comprises:
acquiring a timestamp of each data point of the historical valid data;
extracting at least one time factor of the corresponding data point from the timestamp of each data point of the historical valid data.

4. The method according to claim 3, wherein the at least one time factor comprises: which second of the current day the moment corresponding to the data point is, whether a date including the moment corresponding to the data point is a weekday, which day of a current week the date including the moment corresponding to the data point is, which day of a current month the date including the moment corresponding to the data point is, whether the date including the moment corresponding to the data point is a holiday or festival, and if the date including the moment corresponding to the data point is a holiday or festival, at least one of which holiday or festival.

5. The method according to claim 2, wherein determining the preset data model according to the historical valid data and the at least one time factor of corresponding each data point specifically comprises:
enabling said at least one time factor of each said data point in the historical valid data to form a preset time vector;
considering the preset time vector as an input value of the preset data model, considering the data of a corresponding said data point as an output value of the preset data model, training the preset data model, and determining the preset data model.

6. The method according to of claim 1, wherein predicting a desired value of data of the prediction moment according to a preset data model and said at least one time factor of the prediction moment specifically comprises:
enabling at least one time factor of the prediction moment to form a time vector;
considering the time vector as an input of the preset data model, and obtaining an output value of the preset data model;
considering the output value of the preset data model as a desired value of the data of the prediction moment.

7-12. (canceled)

13. An apparatus, comprising
one or more processors;
a memory;
one or more programs stored in the memory and configured to execute the following operation when executed by the one or more processors:
acquiring at least one time factor of a prediction moment;
predicting a desired value of data of the prediction moment according to a preset data model and said at least one time factor of the prediction moment.

14. The Apparatus according to claim 13, wherein before predicting a desired value of data of the prediction moment according to a preset data model and said at least one time factor of the prediction moment, the operation further comprises:
acquiring historical valid data;
acquiring at least one time factor of each data point of the historical valid data;
determining the preset data model according to the historical valid data and the at least one time factor of corresponding each data point.

15. The Apparatus according to claim 14, wherein the operation of acquiring at least one time factor of each data point of the historical valid data specifically comprises:
acquiring a timestamp of each data point of the historical valid data;
extracting at least one time factor of the corresponding data point from the timestamp of each data point of the historical valid data.

16. The Apparatus according to claim 15, wherein the at least one time factor comprises: which second of the current day the moment corresponding to the data point is, whether a date including the moment corresponding to the data point is a weekday, which day of a current week the date including the moment corresponding to the data point is, which day of a current month the date including the moment corresponding to the data point is, whether the date including the moment corresponding to the data point is a holiday or festival, and if the date including the moment corresponding to the data point is a holiday or festival, at least one of which holiday or festival.

17. The Apparatus according to claim 14, wherein the operation of determining the preset data model according to the historical valid data and the at least one time factor of corresponding each data point specifically comprises:
enabling said at least one time factor of each said data point in the historical valid data to form a preset time vector;
considering the preset time vector as an input value of the preset data model, considering the data of a corresponding said data point as an output value of the preset data model, training the preset data model, and determining the preset data model.

18. The Apparatus according to claim 13, wherein the operation of predicting a desired value of data of the prediction moment according to a preset data model and said at least one time factor of the prediction moment specifically comprises:
enabling at least one time factor of the prediction moment to form a time vector;
considering the time vector as an input of the preset data model, and obtaining an output value of the preset data model;
considering the output value of the preset data model as a desired value of the data of the prediction moment.

19. A non-volatile computer storage medium in which one or more programs are stored, an apparatus being enabled to execute the following operation when said one or more programs are executed by the apparatus:
acquiring at least one time factor of a prediction moment;
predicting a desired value of data of the prediction moment according to a preset data model and said at least one time factor of the prediction moment.

20. The non-volatile computer storage medium according to claim 19, wherein before predicting a desired value of data of the prediction moment according to a preset data model and said at least one time factor of the prediction moment, the operation further comprises:
acquiring historical valid data;
acquiring at least one time factor of each data point of the historical valid data;
determining the preset data model according to the historical valid data and the at least one time factor of corresponding each data point.

21. The non-volatile computer storage medium according to claim 20, wherein the operation of acquiring at least one time factor of each data point of the historical valid data specifically comprises:
acquiring a timestamp of each data point of the historical valid data;
extracting at least one time factor of the corresponding data point from the timestamp of each data point of the historical valid data.

22. The non-volatile computer storage medium according to claim 21, wherein the at least one time factor comprises: which second of the current day the moment corresponding to the data point is, whether a date including the moment corresponding to the data point is a weekday, which day of a current week the date including the moment corresponding to the data point is, which day of a current month the date including the moment corresponding to the data point is, whether the date including the moment corresponding to the data point is a holiday or festival, and if the date including the moment corresponding to the data point is a holiday or festival, at least one of which holiday or festival.

23. The non-volatile computer storage medium according to claim 20, wherein the operation of determining the preset data model according to the historical valid data and the at least one time factor of corresponding each data point specifically comprises:
enabling said at least one time factor of each said data point in the historical valid data to form a preset time vector;
considering the preset time vector as an input value of the preset data model, considering the data of a corresponding said data point as an output value of the preset data model, training the preset data model, and determining the preset data model.

24. The non-volatile computer storage medium according to claim 19, wherein the operation of predicting a desired value of data of the prediction moment according to a preset data model and said at least one time factor of the prediction moment specifically comprises:
enabling at least one time factor of the prediction moment to form a time vector;
considering the time vector as an input of the preset data model, and obtaining an output value of the preset data model;
considering the output value of the preset data model as a desired value of the data of the prediction moment.
